(19) United States
(12) Patent Application Publication
(10) Pub. No.: US 2006/0107164 A1
(43) Pub. Date: May 18, 2006

(54) Method and apparatus for adjusting service rate to adapt to channel conditions

(76) Inventors: Matthew Baer, Germantown, MD (US); Roderick Ragland, Rockville, MD (US); Frank Kelly, Walkersville, MD (US)

Correspondence Address: THE DIRECTV GROUP, INC.;RE/R11/A109, P.O. Box 956, El Segundo, CA, 90245-0956, US

(21) Appl. No.: 11/085,975

(22) Filed: Mar. 22, 2005

Related U.S. Application Data
(60) Provisional application No. 60/616,334, filed on Oct. 6, 2004.

(51) Int. Cl. H04L 1/18; G08C 25/02

(52) U.S. Cl. 714/748

(57) ABSTRACT

An approach is disclosed for a satellite terminal to utilize a lower transmit rate when transmission conditions do not permit the terminal to successfully transmit at a higher, preferred service rate. The terminal monitors retransmissions to determine whether transmission is possible at the higher rate. As an initial measure, the terminal first tries another inroute (or inroute group) at the preferred service rate before any attempt to switch to a lower service rate. If this other inroute group still poses a problem for successful transmission, the terminal switches to a lower service rate. The terminal remains at the lower service rate for a predetermined, configurable amount of time. This arrangement has particular applicability to a satellite network that provides data communication services.

### RELATED APPLICATIONS

This application is related to, and claims the benefit of the earlier filing date under 35 U.S.C. § 119(e) of, U.S. Provisional Patent Application (Ser. No. 60/616,334) filed Oct. 6, 2004 (Attorney Docket: PD-204018), entitled “Scalable Secure Access to Dedicated Resources in a Communication Network”; the entirety of which is incorporated herein by reference.

### FIELD OF THE INVENTION

The present invention relates to communications, and more particularly to an approach for adapting to channel conditions.

### BACKGROUND OF THE INVENTION

Modern satellite communication systems provide a pervasive and reliable infrastructure to distribute voice, data, and video signals for global exchange and broadcast of information. These satellite communication systems have emerged as a viable option to terrestrial communication systems for carrying data traffic (e.g., Internet traffic) as well as telephony traffic. However, satellite communication systems are more susceptible to environmental conditions, which can negatively impact signal transmissions. For example, a temporary rain storm may require greater transmission power from the satellite terminals to maintain service. During such rainy conditions, the signals can be severely attenuated by the water droplets. Conventionally, satellite systems cannot automatically adapt to varying channel conditions to efficiently utilize system resources. Consequently, users lose service, which can eventually translate to loss of revenue to the service provider. Although the service loss may be temporary, users will become less tolerant of these service disruptions if competing technologies can offer higher system availability.

Based on the foregoing, there is a clear need for improved approaches for efficiently utilizing system resources in light of changing channel conditions of a radio communications system.

### SUMMARY OF THE INVENTION

These and other needs are addressed by the present invention, wherein an approach is provided for temporarily switching to a lower rate based upon transmission conditions in a radio communication system.

According to one aspect of the present invention, a method for adapting to transmission conditions in a radio communication system is disclosed. The method includes tracking the number of retransmissions over a first inroute of the radio communication system. The first inroute supports a first rate. The method also includes determining whether the number of retransmissions exceeds a predetermined threshold. Further, the method includes switching to a second inroute of the radio communication system if the number of retransmissions exceeds the predetermined threshold. The second inroute supports a second rate, wherein the second rate is lower than the first rate.

According to another aspect of the present invention, an apparatus for adapting to transmission conditions in a radio communication system is disclosed. The apparatus includes means for tracking the number of retransmissions over a first inroute of the radio communication system. The first inroute supports a first rate. Additionally, the apparatus includes means for determining whether the number of retransmissions exceeds a predetermined threshold. Further, the apparatus includes means for switching to a second inroute of the radio communication system if the number of retransmissions exceeds the predetermined threshold. The second inroute supports a second rate, wherein the second rate is lower than the first rate.

According to another aspect of the present invention, a method for adapting to transmission conditions in a radio communication system is disclosed. The method includes determining that a return channel, associated with a first data rate and a first coding scheme, is not available based upon the number of retransmissions over the return channel. The method also includes switching to another return channel, associated with a second data rate and a second coding scheme, wherein at least the first data rate or the first coding scheme is different from the second data rate or the second coding scheme.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various obvious respects, all without departing from the spirit and scope of the present invention. Accordingly, the drawings and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram of a satellite communication system capable of switching service rate to combat transmission conditions, according to an embodiment of the present invention;

FIG. 2 is a diagram of a communication session between two satellite terminals of FIG. 1, each capable of deploying service rate fallback, according to an embodiment of the present invention;

FIG. 3 is a flowchart of a rate fallback process, in accordance with an embodiment of the present invention;

FIG. 4 is a flowchart of a process for reverting back to a preferred service rate after operating at a lower service rate, in accordance with an embodiment of the present invention, in accordance with an embodiment of the present invention;

FIG. 5 is a flowchart of a process for reselecting a different inroute, in accordance with an embodiment of the present invention; and

FIG. 6 is a diagram of hardware that can be used to implement an embodiment of the present invention.

### DESCRIPTION OF THE PREFERRED EMBODIMENT

A method, apparatus, and software for adapting to transmission conditions in a radio communication system are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

The present invention provides an approach for a satellite terminal to utilize a lower transmit rate when transmission conditions do not permit the terminal to successfully transmit at a higher, preferred service rate. The terminal monitors message retransmissions (e.g., ALOHA messages) to determine whether transmission is possible at the higher rate. As an initial measure, the terminal first attempts to transmit using another inroute (or inroute group) at the preferred service rate before any attempt to switch to a lower service rate. If the new inroute group still poses a problem for successful transmission, the terminal switches to a lower service rate. The terminal remains at the lower service rate for a predetermined, configurable amount of time. Before returning to the higher rate, an empty ALOHA burst is sent at the higher preferred service rate to determine whether the higher preferred service rate is accessible. This approach advantageously enhances system availability, even under adverse channel conditions.

Although the present invention is discussed with respect to a satellite communication system, it is recognized by one of ordinary skill in the art that the present invention has applicability to any type of radio communication system.

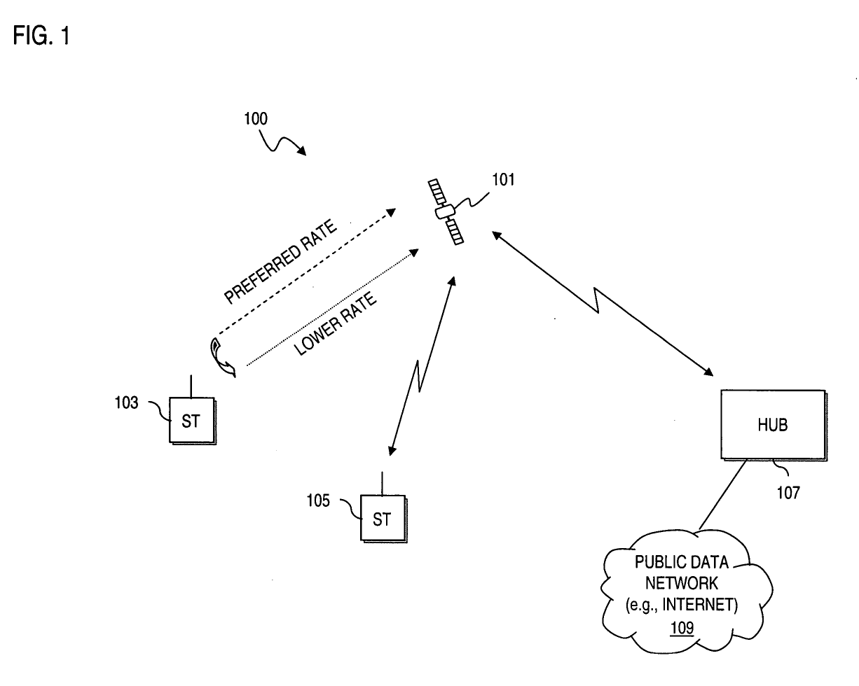

FIG. 1 is a diagram of a satellite communication system capable of switching service rate to combat transmission conditions, according to an embodiment of the present invention. A satellite communication system 100 utilizes a satellite 101 to transmit information, bi-directionally, to and from satellite terminals (STs) 103, 105 and a hub 107. As used herein, “return channel”, “inroute”, and “uplink channel” are synonymously used to denote a communication channel established via the satellite 101 to transport data in the direction from the STs 103, 105 to the satellite 101. The terms “receive channel”, “outroute” and “downlink channel” refer to a communication channel carrying traffic in the direction from the satellite 101 to the STs 103, 105. For the purposes of explanation, the return channel can include multiple carriers, each operating at speeds, for example, of 64 kbps, 128 kbps, or 256 kbps. In an exemplary embodiment, each of these carriers is a TDMA (Time Division Multiple Access) stream, which employs several transmission schemes as listed in Table 1.

As shown, the ST 103 transmits over an inroute at a preferred “rate.” However, should channel conditions change (e.g., rain storm) such that this preferred service rate cannot be supported, the ST 103 can independently detect the change without explicit information from the hub 107. Subsequently, the ST 103 can switch temporarily to a lower service rate until the channel conditions improve—e.g., intensity of the rain storm has subsided. This capability to fallback permits the ST 103 to continue data transmission, which can be critical depending on the nature of the application. For instance, if the ST 103 is transmitting information regarding a financial transaction, a halting of such transaction can result in loss of business for the subscriber.

According to an embodiment of the present invention, the term “service rate” as used herein refers to the combination of the inroute “speed” or transmit rate in addition to the coding mechanism. Exemplary service rates supported by the system 100 are enumerated below in Table 1:

TABLE 1

| SERVICE | TRANSMIT | |
|---|---|---|
| RATE | RATE | CODING SCHEME |
| 1 | 64 kbps | Convolutional (sequential) |
| 2 | 128 kbps | Convolutional (sequential) |
| 3 | 256 kbps | Convolutional (sequential) |
| 4 | 128 kbps | Turbo coding |
| 5 | 256 kbps | Turbo coding |
| 6 | 128 kbps | Turbo coding under overlay |
| 7 | 256 kbps | Turbo coding under overlay |

In terms of service preference, the ordering, according to one embodiment of the present invention, is as follows: sequential is the lowest, followed by turbo coding, with turbo coding under overlay at the highest preferred service rate. Under this ordering scheme, the lowest “rate” is 64 kbps sequential, and the highest “rate” is 256 k-turbo coding under overlay. It is noted that the highest rate available on the outroute is selected if the terminal is able to range at the rate.

In the system 100, the STs 103, 105 originate traffic from a particular coverage area and may exchange data among themselves as well as other STs (not shown). In an exemplary embodiment, the STs 103, 105 are Very Small Aperture Terminals (VSAT), and can provide access to a public data network 109, such as the Internet, via the hub 107.

In an exemplary embodiment, the hub 107 operates as part of a Network Operations Center (NOC). The NOC 107 manages and controls communication services and operations. For example, the NOC 107 provisions and identifies the communication channels that are to be allocated. Additionally, the NOC 107 is responsible for controlling the bandwidth that is made available to the STs 103, 105.

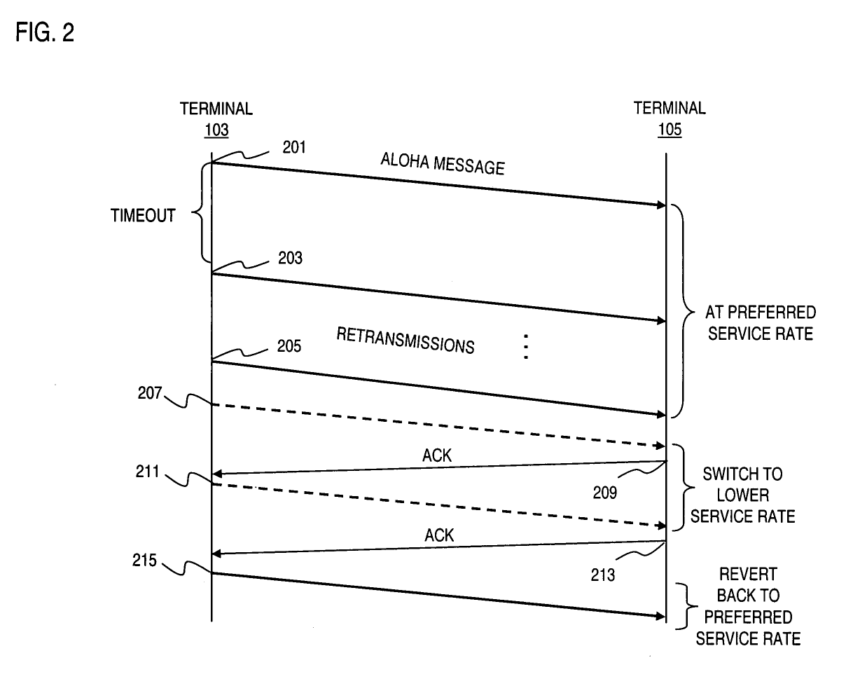

FIG. 2 is a diagram of a communication session between two satellite terminals of FIG. 1, each capable of deploying service rate fallback, according to an embodiment of the present invention. By way of example, the ST 103 communicates with the ST 105 using contention channels (e.g., ALOHA protocol) supported by the system 100. These contention channels, for instance, follow the ALOHA protocol, which permits any user with data to send to begin transmitting onto the contention channel without having to reserve a transmission slot ahead of time. In the event of a collision, the receiving terminal simply ignores the transmission. If the data is received successfully, an Acknowledgment (ACK) is provided by the receiving terminal to the sending terminal. If no ACK is ever received and the timeout period lapses, the sending terminal retransmits the data.

In step 201, the terminal 103 sends data at a preferred service rate. It is noted that the preferred service rate is predetermined based upon, for instance, the subscriber's service agreement. After a timeout period, the terminal 103 begins a series of retransmissions, which are still at the preferred service rate, per steps 203 and 205. The terminal 103, however, does not immediately switch to the lower service rate. In step 205, the terminal 103 selects another inroute, at the preferred service rate, to attempt the transmission.

Under this scenario, the rain fade is severe enough to affect the other inroute, and thus, the terminal 103 switches to a lower service rate, as in step 207. At this point, the terminal 105 receives the transmission successfully and sends an ACK, per step 209. The terminal 103 continues to use the lower service rate for a predetermined duration, resulting in the transmissions shown in steps 211 and 213. Thereafter, in step 215, the terminal 103 reverts back to the preferred service rate, and transmits more data at this original service rate.

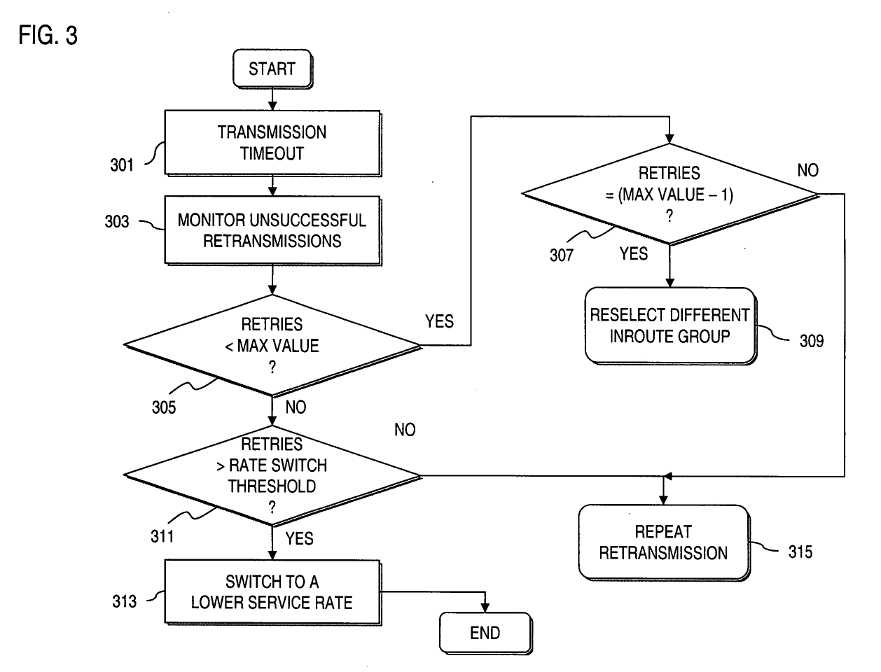

The processes for detecting the unsuccessful transmissions and switching to a lower service rate are more fully explained below in FIG. 3.

FIG. 3 is a flowchart of a rate fallback process, in accordance with an embodiment of the present invention. If severe weather moves into or develops within the coverage area of a terminal, the terminal's transmit power received at the NOC 107 may be lower than normal. It may be at a sufficiently low level that the bursts are not detected by the hardware of the hub 107. To detect and address this scenario, the terminal 103 monitors the ALOHA retransmissions for a given session, after the transmission timeout period (steps 301 and 303) expires.

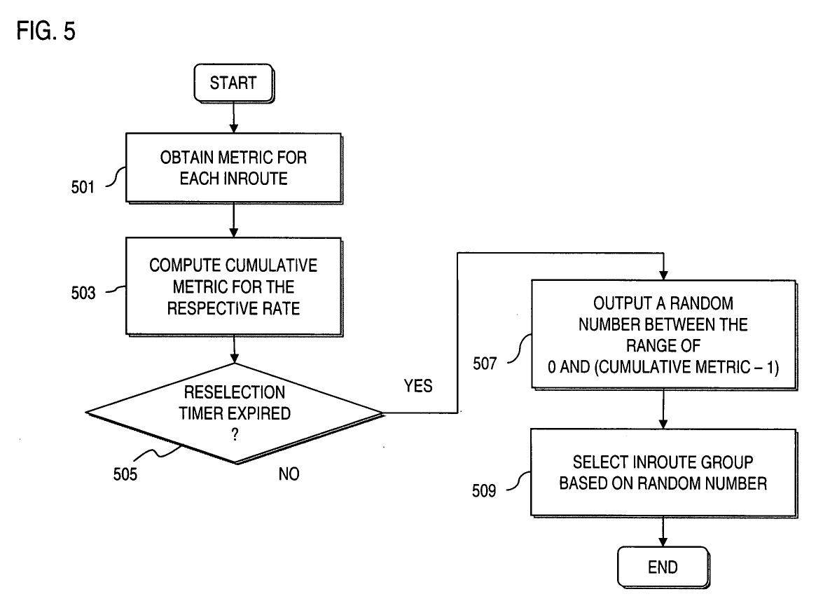

In step 305, the terminal 103 determines whether the number of retries is below a configurable maximum value of retries. The NOC 107 can send a message to indicate this maximum value of ALOHA retries before the terminal 103 should flush its queues. This ALOHA retries parameter is used to determine when to try another inroute (or inroute group) at the same rate and when a lower service rate should be tried. It should be noted that a particular inroute group may be experiencing problems that result in ALOHA bursts not being acknowledged. To accommodate this possibility, the terminal 103 will try a different inroute group at the same rate before falling back to a lower service rate. Accordingly, in step 307, the terminal 103, in an exemplary embodiment, checks whether the number of retries is equal to one less than the maximum value; if so, a different inroute group is select, per step 309. This reselection process is more fully described with respect to FIG. 5.

Returning to the decision point of step 305, if the maximum value is not exceeded, then the terminal 103 determines, as in step 311, whether the number of retries exceeds a threshold that is designated for when a switch to a lower service rate should occur (denoted as “Rate Switch Threshold”). If indeed the Rate Switch Threshold has been exceeded, then the terminal 103 switches to the lower service rate. As previously mentioned, a rate specifies a combination of transmit rate and coding scheme, and thus, a lower service rate could indicate an identical transmit rate with a different coding scheme, or a lower transmit rate with the same coding scheme. The “lower” service rate can be negotiated as part of the service agreement with the subscriber. According to an embodiment of the present invention, the terminal 103 falls back by one rate, as reducing the rate by one level should be sufficient to overcome power loss due to weather. In practical systems, if the weather were severe enough, the outroute would likely be lost so the terminal 103 would be unable to transmit anyway. In step 315, if the Rate Switch Threshold has not been exceeded, the terminal 103 merely repeats its retransmission process.

The above fallback process is passive in that it does not rely on explicit information, such as control messages sent from the hub 107 for relaying received power or other error condition information.

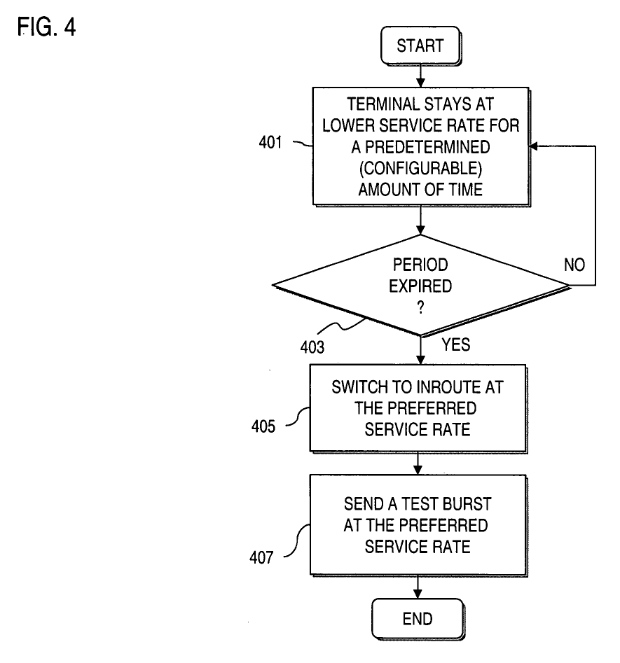

FIG. 4 is a flowchart of a process for reverting back to a preferred service rate after operating at a lower service rate, in accordance with an embodiment of the present invention. When the terminal 103 drops to a lower service rate due to excessive ALOHA retransmissions, the terminal 103 remains at the lower service rate for a configurable amount of time (denoted as “rain fade backoff period”), per step 401. This information can be conveyed by the NOC 107 as part of a message that indicates, in frames, the rain fade backoff period. If no such time parameter exists, a default parameter (e.g., 15 minutes) can be adopted. Upon determining that the backoff period is expired, the terminal 103 switches to an inroute at the preferred service rate, per steps 403 and 405.

Alternatively, a “backoff” down counter can be maintained by the terminal 103, such that the backoff down counter is decremented every frame. Once the backoff down counter reaches zero, the terminal 103 will switch back up to the preferred service rate, if the terminal 103 is currently not active. If the remote is active when the backoff down counter reaches zero, the rate switch will occur after the terminal 103 goes inactive.

In step 407, the terminal 103 sends a test burst (e.g., an empty ALOHA burst) at the preferred service rate to determine whether the preferred service rate is available. If the preferred service rate is unavailable, then the terminal 103 may need to switch back to the lower service rate once again.

As explained previously, the terminal 103 has the capability try a different inroute group before having to switch to a lower service rate. This capability is now detailed below in FIG. 5.

FIG. 5 is a flowchart of a process for reselecting a different inroute, in accordance with an embodiment of the present invention. Inroute selection is based on an ALOHA metric that is advertised by each of the inroute (or inroute groups). Each inroute group has an associated rate, and a dynamic ALOHA Metric. In steps 501 and 503, the terminal 103 adds each inroute group's ALOHA Metric to a cumulative ALOHA Metric for the respective rate. When the reselection timer expires, the terminal 103 outputs a random number between 0 and (Cumulative ALOHA Metric-1) such that a weighted random selection occurs (steps 505 and 507). In step 509, the new inroute group is selected based on the random number.

The processes associated with the fallback feature detailed above can be executed through a variety of hardware and/or software configurations.

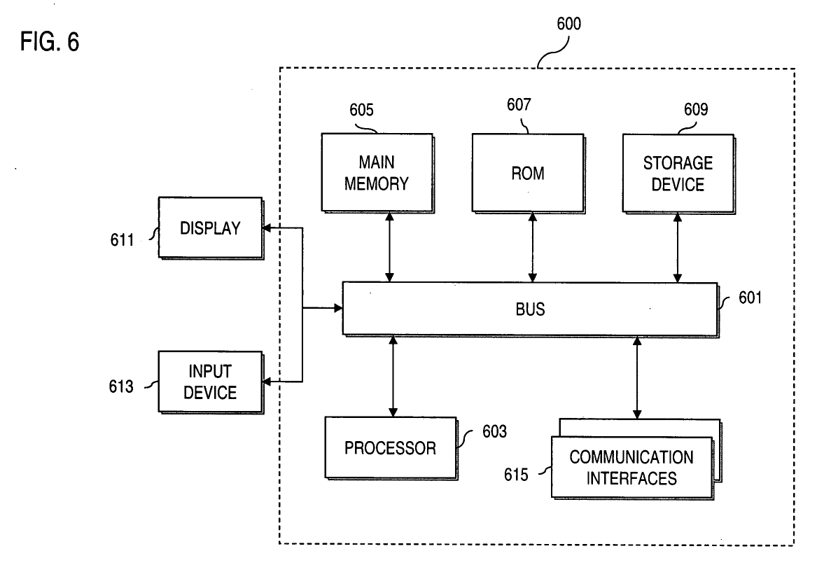

FIG. 6 illustrates a computer system 600 upon which an embodiment according to the present invention can be implemented. The computer system 600 includes a bus 601 or other communication mechanism for communicating information, and a processor 603 coupled to the bus 601 for processing information. The computer system 600 also includes main memory 605, such as a random access memory (RAM) or other dynamic storage device, coupled to the bus 601 for storing information and instructions to be executed by the processor 603. Main memory 605 can also be used for storing temporary variables or other intermediate information during execution of instructions to be executed by the processor 603. The computer system 600 further includes a read only memory (ROM) 607 or other static storage device coupled to the bus 601 for storing static information and instructions for the processor 603. A storage device 609, such as a magnetic disk or optical disk, is additionally coupled to the bus 601 for storing information and instructions.

The computer system 600 may be coupled via the bus 601 to a display 611, such as a cathode ray tube (CRT), liquid crystal display, active matrix display, or plasma display, for displaying information to a computer user. An input device 613, such as a keyboard including alphanumeric and other keys, is coupled to the bus 601 for communicating information and command selections to the processor 603. Another type of user input device is cursor control 615, such as a mouse, a trackball, or cursor direction keys for communicating direction information and command selections to the processor 603 and for controlling cursor movement on the display 611.

According to one embodiment of the invention, the processes of FIGS. 3-5 are provided by the computer system 600 in response to the processor 603 executing an arrangement of instructions contained in main memory 605. Such instructions can be read into main memory 605 from another computer-readable medium, such as the storage device 609. Execution of the arrangement of instructions contained in main memory 605 causes the processor 603 to perform the process steps described herein. One or more processors in a multi-processing arrangement may also be employed to execute the instructions contained in main memory 605. In alternative embodiments, hard-wired circuitry may be used in place of or in combination with software instructions to implement the embodiment of the present invention. Thus, embodiments of the present invention are not limited to any specific combination of hardware circuitry and software.

The computer system 600 also includes a communication interface 617 coupled to bus 601. The communication interface 617 provides a two-way data communication coupling to a network link 619 connected to a local network 621. For example, the communication interface 617 may be a digital subscriber line (DSL) card or modem, an integrated services digital network (ISDN) card, a cable modem, or a telephone modem to provide a data communication connection to a corresponding type of telephone line. As another example, communication interface 617 may be a local area network (LAN) card (e.g. for Ethernet™ or an Asynchronous Transfer Model (ATM) network) to provide a data communication connection to a compatible LAN. Wireless links can also be implemented. In any such implementation, communication interface 617 sends and receives electrical, electromagnetic, or optical signals that carry digital data streams representing various types of information. Further, the communication interface 617 can include peripheral interface devices, such as a Universal Serial Bus (USB) interface, a PCMCIA (Personal Computer Memory Card International Association) interface, etc.

The network link 619 typically provides data communication through one or more networks to other data devices. For example, the network link 619 may provide a connection through local network 621 to a host computer 623, which has connectivity to a network 625 (e.g. a wide area network (WAN) or the global packet data communication network now commonly referred to as the “Internet”) or to data equipment operated by service provider. The local network 621 and network 625 both use electrical, electromagnetic, or optical signals to convey information and instructions. The signals through the various networks and the signals on network link 619 and through communication interface 617, which communicate digital data with computer system 600, are exemplary forms of carrier waves bearing the information and instructions.

The computer system 600 can send messages and receive data, including program code, through the network(s), network link 619, and communication interface 617. In the Internet example, a server (not shown) might transmit requested code belonging an application program for implementing an embodiment of the present invention through the network 625, local network 621 and communication interface 617. The processor 603 may execute the transmitted code while being received and/or store the code in storage device 69, or other non-volatile storage for later execution. In this manner, computer system 600 may obtain application code in the form of a carrier wave.

The term “computer-readable medium” as used herein refers to any medium that participates in providing instructions to the processor 603 for execution. Such a medium may take many forms, including but not limited to non-volatile media, volatile media, and transmission media. Non-volatile media include, for example, optical or magnetic disks, such as storage device 609. Volatile media include dynamic memory, such as main memory 605. Transmission media include coaxial cables, copper wire and fiber optics, including the wires that comprise bus 601. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the present invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistance (PDA) and a laptop. An infrared detector on the portable computing device receives the information and instructions borne by the infrared signal and places the data on a bus. The bus conveys the data to main memory, from which a processor retrieves and executes the instructions. The instructions received by main memory may optionally be stored on storage device either before or after execution by processor.

Accordingly, the above approach provides a capability for a terminal to recognize when it is unable to successfully transmit at a particular service rate and temporarily switch to a lower service rate when this occurs. Because the terminal has no knowledge of the current weather conditions at the terminal's site, the ALOHA retransmission count is monitored to detect a possible transmission problem. If the terminal continues to transmit at the lower service rate, until a configurable amount of time. This mechanism advantageously permits efficient use of system resources in the face of changing channel conditions.

While the present invention has been described in connection with a number of embodiments and implementations, the present invention is not so limited but covers various obvious modifications and equivalent arrangements, which fall within the purview of the appended claims.

What is claimed is:

1. A method for adapting to transmission conditions in a radio communication system, the method comprising:
tracking the number of retransmissions over a first inroute of the radio communication system, the first inroute supporting a first rate;
determining whether the number of retransmissions exceeds a predetermined threshold; and
switching to a second inroute of the radio communication system if the number of retransmissions exceeds the predetermined threshold, the second inroute supporting a second rate, wherein the second rate is lower than the first rate.

2. A method according to claim 1, wherein the first inroute is part of an inroute group that includes a plurality of inroutes supporting the first rate, the method further comprising:
selecting, from the inroute group, an inroute that is different from the first inroute before switching to the second inroute.

3. A method according to claim 2, wherein the selected inroute is based on an accumulated metric value.

4. A method according to claim 1, wherein each of the rates is specified by a data rate and a coding scheme.

5. A method according to claim 1, further comprising:
transmitting data over the second inroute for a predeterminded duration; and
after the predetermined duration, switching to an inroute of the first rate.

6. A method according to claim 1, wherein the radio communication system is a satellite communication system, and the inroutes are contention channels.

7. A method according to claim 1, wherein the contention channels support an ALOHA-based communication protocol.

8. A computer-readable medium bearing instructions for adapting to transmission conditions in a radio communication system, said instruction, being arranged, upon execution, to cause one or more processors to perform the method of claim 1.

9. An apparatus for adapting to transmission conditions in a radio communication system, the apparatus comprising:
means for tracking the number of retransmissions over a first inroute of the radio communication system, the first inroute supporting a first rate;
means for determining whether the number of retransmissions exceeds a predetermined threshold; and
means for switching to a second inroute of the radio communication system if the number of retransmissions exceeds the predetermined threshold, the second inroute supporting a second rate, wherein the second rate is lower than the first rate.

10. An apparatus according to claim 9, wherein the first inroute is part of an inroute group that includes a plurality of inroutes supporting the first rate, the apparatus further comprising:
means for selecting, from the inroute group, an inroute that is different from the first inroute before switching to the second inroute.

11. An apparatus according to claim 10, wherein the selected inroute is based on an accumulated metric value.

12. An apparatus according to claim 9, wherein each of the rates is specified by a data rate and a coding scheme.

13. An apparatus according to claim 9, further comprising:
means for transmitting data over the second inroute for a predeterminded duration; and
after the predetermined duration, means for switching to an inroute of the first rate.

14. An apparatus according to claim 9, wherein the radio communication system is a satellite communication system, and the inroutes are contention channels.

15. An apparatus according to claim 9, wherein the contention channels support an ALOHA-based communication protocol.

16. A method for adapting to transmission conditions in a radio communication system, the method comprising:
determining that a return channel, associated with a first data rate and a first coding scheme, is not available based upon the number of retransmissions over the return channel; and
switching to another return channel, associated with a second data rate and a second coding scheme, wherein at least the first data rate or the first coding scheme is different from the second data rate or the second coding scheme.

17. A method according to claim 16, further comprising:
switching back to the return channel after a predeterminded duration.

18. A method according to claim 16, wherein the radio communication system is a satellite communication system, and the return channels are contention channels.

19. A method according to claim 16, wherein the contention channels support an ALOHA-based communication protocol.

20. A computer-readable medium bearing instructions for adapting to transmission conditions in a radio communication system, said instruction, being arranged, upon execution, to cause one or more processors to perform the method of claim 16.
